(19) United States
(12) Patent Application Publication
(10) Pub. No.: US 2007/0279855 A1
(43) Pub. Date: Dec. 6, 2007

(54) Removable laptop computer cover for the purpose of displaying advertising or indicia

(76) Inventors: Patricia Linsmeier, Sussex, WI (US); Linda Ann Lindquist, Sussex, WI (US)

Correspondence Address: Patricia Linsmeier Jackson, W279 N5322 Hanover Hill Ct., Sussex, WI, 53089, US

(21) Appl. No.: 11/445,665

(22) Filed: Jun. 2, 2006

(51) Int. Cl. G06F 1/16

(52) U.S. Cl. 361/683

(57) ABSTRACT

A removable, printed stretchable, thin cloth cover that covers the backside of a laptop computer screen. The cover comprises of four sewn corners made from an L-shaped notch (1) cut from the corners of the fabric. The sewn corners (2) of the cover extend over the edges of the laptop computer and wrap around to the front screen side. The central portion of the cover preferably displays indicia such and advertising, personal messages or other promotional material. The top edge of the cover extends to the inside edge of the computer lid without inhibiting the function of the closing tabs or screen visibility. The bottom edge of the cover extends to the bottom hinge (4) of the laptop cover without obstructing the functionality of the moving parts.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF INVENTION

1. Field of the Invention

This present invention relates generally to a laptop computer cover, specifically to an enhanced function of a backside of a laptop computer's screen using colored, dyed stretchable material arranged to form display indicia including but not limited to, advertisement, trademarks, logos, website addresses, contact information, personal messages, corporation information, graphics and designs.

2. Prior Art

Once purchased and used in public, the backside of a laptop computer's screen only displays the manufacturer of the laptop. This present invention provides a removable means to personalize the backside of a laptop computer, displaying advertising or other indicia without impairing or altering the use and value of the laptop computer.

3. Object and Advantages

Accordingly several objects and advantages of this invention are:

(a) to provide a large, visible, impressionable, readable form of advertising or indicia;

(b) to provide a unique, novel, noticeable statement or graphics of laptop owner's choice;

(c) to provide a means for immediate contact and generation of business;

(d) to provide consumer information in a public, interactive environment;

(e) to provide a removable form of display;

(f) to maintain the functionality and workability of the laptop computer with or without the invention application;

(g) to provide a visual of the person within a corporation of interest;

(h) to provide a means for laptop user to be known.

Further objects and advantages are to provide individuation, art or advertising that is functional, removable and compatible with the computer's functions, screen visibility, ability to close and ability to be transported with ease. Still further objects and advantages is the function of putting a name to the face, or a face to the text of the advertisement or indicia.

### SUMMARY

The present invention is directed to a removable cover for the backside of a laptop computer screen. The removable cover is customized to fit on the backside of a laptop computer screen. The cover comprises of a colored, dyed, stretchable material that stretches across the backside of the laptop computer screen and could display advertising, logo, graphics, designs and business information. Many business people conduct business on laptop computers in public places: coffee shops, clubs, restaurants, airports and libraries. The people behind these laptops are not visible or known. These public locations are an optimal space for generating future business prospects. The opportunity to network with future customers is gained by the recognition, familiarity and approachability of the laptop user.

### DRAWINGS—FIGURES

FIG. 1 is a perspective view of the laptop computer cover material when cut.

FIG. 2 is a perspective view of the inside of the laptop computer cover when cut and sewn at the four corners.

FIG. 3 is a perspective outside view of the laptop computer cover according to the present invention.

FIG. 4 is a perspective inside view of the laptop computer cover according to the present invention.

### DETAILED DESCRIPTION OF THE PREFERRED EMBODIMENT

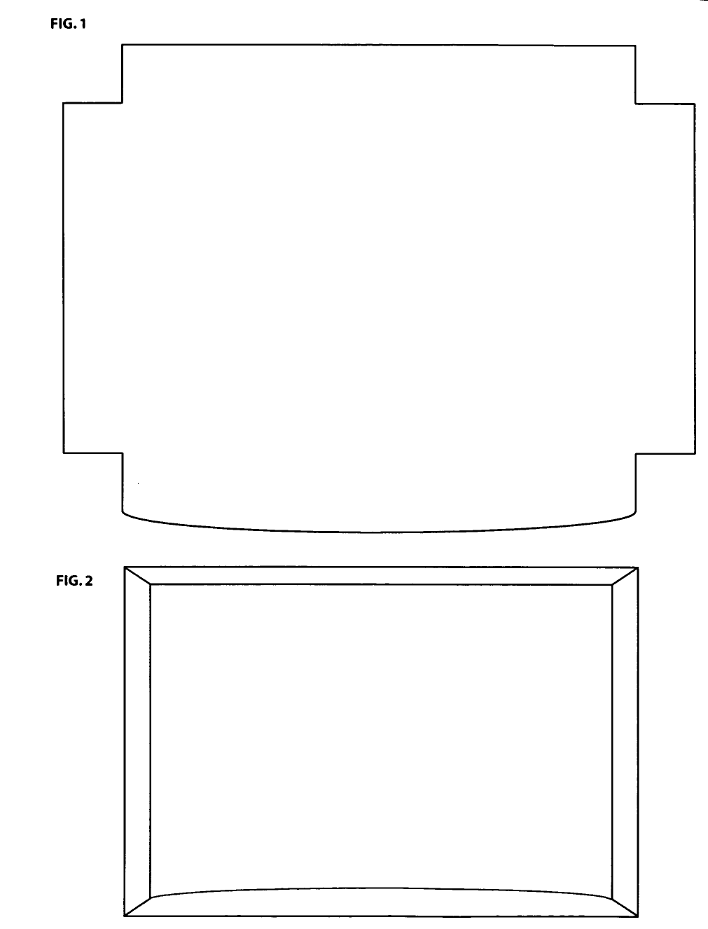

FIG. 1 illustrates the cut pattern of dyed stretchable material custom cut to fit the outside of an individual laptop computer screen.

FIG. 2 illustrates the cut dyed stretchable material with stitching required to form four corner pockets which, when stretched, will fit over the four corners of a laptop computer cover.

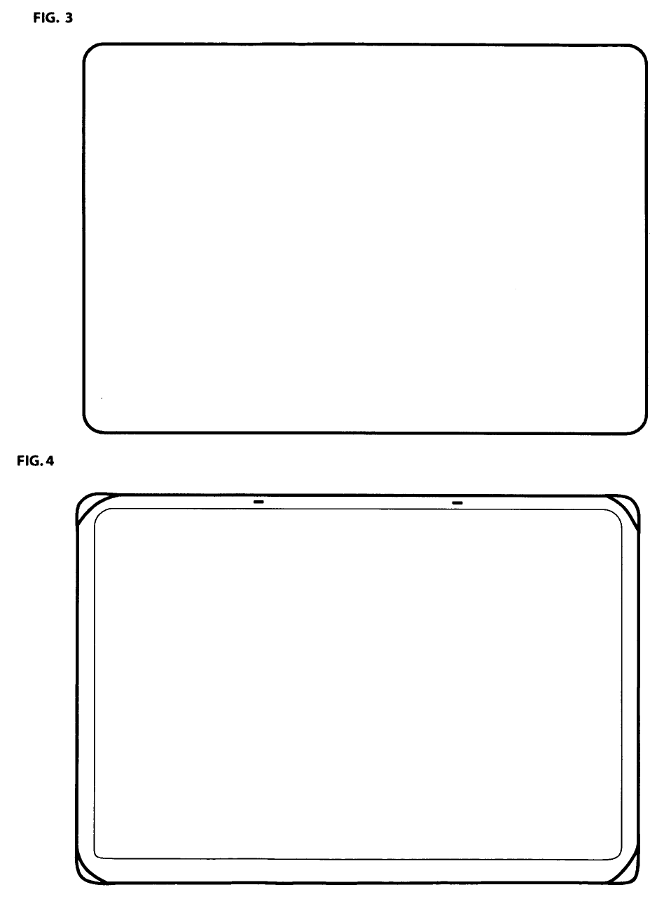

FIG. 3 illustrates the present invention fitted to the outside of the computer cover

FIG. 4 illustrates the present invention fitted to the outside of the computer cover, inside view. The four corners of present invention are stretched over and extending just past the inside edge of each corner. The top and bottom edge of present invention arches to provide clearance for the locking and hinge mechanisms for the closing function of the laptop computer cover.

We claim:

1. An apparatus in combination with a laptop computer comprising: a colored, dyed stretchable material with four sewn corners forming a rectangle that is stretched to fit to the backside of a laptop computer's screen, and wherein each of the corners of said invention extend over the laptop computer's front screen side wherein these corners secure the respective fabric to the backside of the laptop computer's screen.
